(19) United States
(12) Patent Application Publication
(10) Pub. No.: US 2016/0232237 A1
(43) Pub. Date: Aug. 11, 2016

(54) METHOD AND DEVICE FOR AN ENGINE TO CRAWL, VALIDATE, AND PROVIDE OPEN-TYPE ABSTRACT INFORMATION OF A WEBPAGE

(71) Applicant: BEIJING QIHOO TECHNOLOGY COMPANY LIMITED, Beijing (CN)

(72) Inventor: Ruifeng YUAN, Beijing (CN)

(73) Assignee: Beijing Qihoo Technology Company Limited, Beijing (CN)

(21) Appl. No.: 15/025,236

(22) PCT Filed: Aug. 12, 2014
(86) PCT No.: PCT/CN2014/084206

§ 371 Date: Mar. 25, 2016

(30) Foreign Application Priority Data
Sep. 26, 2013 (CN) 201310445150.9
Sep. 26, 2013 (CN) 201310445194.1
Sep. 26, 2013 (CN) 201310445238.0
Sep. 26, 2013 (CN) 201310445329.4

(51) Int. Cl. G06F 17/30; G06F 17/22

(52) U.S. Cl. CPC G06F 17/30864; G06F 17/2247; G06F 17/30914; G06F 17/3053

(57) ABSTRACT

The present invention discloses a method and device for an engine to crawl, validate and provide the open-type abstract information of webpage. Wherein, the method for a search engine to crawl the open-type abstract information of webpage, comprises: detecting whether a preset identification of open-type abstract information is included in webpage information when the webpage information is crawled; and if it is detected the identification is included in the webpage information, crawling a protocol header in the webpage information which describes structure of the open-type abstract information and webpage content mapped with the structure described in the open-type abstract information. The present invention is able to adjust the content of the open-type abstract information that a search engine crawls, and greatly enrich the display forms of the abstract webpage information.

### CROSS-REFERENCE TO RELATED APPLICATIONS

This application is a national stage of International Application No. PCT/CN2014/084206, filed Aug. 12, 2014, which is based upon and claims priority to Chinese Patent Applications No. CN201310445238.0, No. CN201310445150.9, No. CN201310445194.1 and No. CN201310445329.4, all of which are filed Sep. 26, 2013, the entire contents of all of which are incorporated herein by reference.

### FIELD OF TECHNOLOGY

The present invention relates to the field of Internet technologies and, more particularly, to a method and device for an engine to crawl, validate, and provide open-type abstract information of webpage.

### BACKGROUND

When a user uses a search engine to search, the search engine will return multiple search results and present them for the user to view according to the search keyword the user inputs. However, different users sometimes have different preferences for sites. At present, the major search engines, when crawling the content of a website, extract only according to the simple robots protocol (also known as the crawlers protocol, the crawlers rule, the robots protocol, etc.), and provide simple information displays according to the matching degree when a user searches, which makes that the matching degree between the website information and the user's search needs is not high, display effects are poor, conversion rates of search results are low, the content is incapable of being validated, and other technical problems.

### SUMMARY

In light of above problems, the present invention is proposed to provide a method and device for an engine to crawl, validate, and provide open-type abstract information of a webpage, which overcome above problems, or at least partially solve or alleviate above problems.

According to an aspect of the invention, there is provided a method for a search engine to crawl open-type abstract information of webpage, comprises: detecting whether a preset identification of open-type abstract information is included in webpage information when the webpage information is crawled; and if it is detected the identification is included in the webpage information, crawling a protocol header in the webpage information which describes structure of the open-type abstract information and webpage content mapped with the structure described in the open-type abstract information.

According to another aspect of the invention, there is provided a device for a search engine to crawl the open-type abstract information of webpage, comprising: a detection module, configured to detect whether a preset identification of open-type abstract information is included in webpage information when the webpage information is crawled; a crawl module, configured to crawl a protocol header in the webpage information which describes structure of the open-type abstract information and webpage content mapped with the structure described in the open-type abstract information if it is detected the identification is included in the webpage information.

According to another aspect of the invention, there is also provided a computer program comprising computer readable codes, and when the computer readable codes are executed on a computer, it executes the method for a search engine to crawl open-type abstract information of a webpage.

According to another aspect of the invention, a computer readable medium is provided which stores the foregoing computer program.

According to one aspect of the invention, there is provided a method for validating open-type abstract information of a webpage, comprising: validating whether a rendering result of rendering the open-type abstract information is successful if it is detected a preset identification of open-type abstract information is included in webpage information;

validating a format of the open-type abstract information or validating webpage content of the open-type abstract information according to a predefined rule.

According to another aspect of the invention, there is provided a device for validating open-type abstract information of a webpage, comprising: a first validation module, configured to validate whether a rendering result of rendering open-type abstract information is successful if it is detected a preset identification of open-type abstract information is included in webpage information; and a second validation module, configured to validate a format of the open-type abstract information and/or webpage content of the open-type abstract information according to a predefined rule.

According to another aspect of the invention, there is provided with a computer program comprising computer readable codes, when the computer readable codes are executed on a computer, it executes the method for validating the open-type abstract information of a webpage.

According to another aspect of the invention, a computer readable medium is provided which stores the foregoing computer program.

According to one aspect of the invention, there is provided a method for a search engine to provide open-type abstract information of webpage, comprising: receiving a search request; searching webpage content which matches the search request in an open-type abstract database; and returning rendering result of rendering the open-type abstract information to the webpage to the webpage matching the search request, to take the rendering result as a search result of the search request.

According to another aspect of the invention, there is provided A device for a search engine to provide open-type abstract information of a webpage, comprising: a receiving module, configured to receive a search request; a search module, configured to search webpage content which matches the search request in an open-type abstract database; and a providing module, configured to return rendering result of rendering the open-type abstract information for the webpage which matches the search request, to take the rendering result as a search result of the search request.

According to another aspect of the invention, there is provided computer program comprises computer readable codes, and when the computer readable codes are executed on a computer, it executes the method for a search engine to provide the open-type abstract information of a webpage.

According to another aspect of the invention, a computer readable medium is provided which stores the foregoing computer program.

According to one aspect of the invention, there is provided A method for a search engine to provide open-type abstract information of a webpage, comprising: when a search request is received, returning rendering results of the open-type abstract information of multiple webpages which include a keyword matching the search request, to take the rendering results as search results of the search request; and ranking the search results in response to a ranking request based on a specific element in the open-type abstract information.

According to another aspect of the invention, there is provided a device for a search engine to provide the open-type abstract information of webpage, comprising: a providing module, configured to, when a search request is received, return rendering results of the open-type abstract information of multiple webpages which include a keyword matching the search request, to take the rendering results as search results of the search request; and a ranking module, configured to rank the search results in response to a ranking request based on a specific element in the open-type abstract information.

According to another aspect of the invention, there is provided with a computer program comprises computer readable codes, and when the computer readable codes are executed on a computer, it executes the method for an engine to provide the open-type abstract.

According to another aspect of the invention, a computer readable medium is provided which stores the foregoing computer program.

The invention has the beneficial effects of:

According to the foregoing method and device for a search engine to crawl the open-type abstract information of webpage provided by the present invention, when the webpage information is crawled, when it is detected that an identification is included in the webpage information, the protocol header which describes of the structure of the open-type abstract information in the webpage information and the webpage content mapped with the structure described in the open-type abstract information are crawled, thus facilitating to adjust the search engine to crawl the content of the open-type abstract information of webpage, greatly enriching the display forms of the abstract information of webpage. For example: assuming the webpage content mapped with the structure described in the open-type abstract information is the text content, the open-type abstract information includes: related information aiming at giving users general understanding about the webpage content, as well as the information of the relation between the webpage content and users' searches and queries. For example: besides ratings and comments, the information that helps users determine the correlation degree of the search, such as “pictures of the product”, “the price of the product”, “whether in stock”, etc., is also able to be added. If a search engine understands the content in the webpage, it is able to display the above search result in the search results according to the content. This search result is able to help search users have intuitive understandings of whether the site and the user's original search intentions are related and matching, thereby obtaining a higher click rate.

According to the foregoing method and device for validating the open-type abstract information of webpage, through validating the open-type abstract information, on the one hand, the efficiency of webpage rendering is improved, on the other hand, the display forms of the abstract webpage information is greatly enriched.

According to the foregoing method and device for providing the open-type abstract information of webpage provided by the invention, for the webpages which match the search requests, the rendering result of rendering the open-type abstract information is returned, so as to take the rendering result as the search result of the search request. Because the content of the open-type abstract information is able to be adjusted conveniently, the display forms of the abstract webpage information may be greatly enriched.

According to the foregoing method and device for providing the open-type abstract information of webpage of the search engine provided by the invention, it is able to be in response to the ranking request based on the specific element in the open-type abstract information, and rank the search results. For example, the search results may be ranked according to information such as “the price of the product”, “comments”, “whether in stock”, which greatly enriches the display forms of the abstract webpage information.

The above description is merely an overview of technical solutions of the present invention. In order to understand the technical solutions of the present invention more clearly and enable to implement in accordance with the content of the description, and in order to make the foregoing and other objects, features and advantages of the invention more apparent and easier to understand, concrete embodiments of the invention will be provided below.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the invention. Further, throughout the drawings, same elements are indicated by same reference numbers. In the drawings:

FIG. 1 is a flow chart showing the method 100 for a search engine to crawl the open-type abstract information of webpage according to an embodiment of the invention;

FIG. 2 is a flow chart showing the method 200 for validating the open-type abstract information of webpage according to an embodiment of the invention;

FIG. 3 is a flow chart showing the method 300 for a search engine to provide the open-type abstract information of webpage according to an embodiment of the invention;

FIG. 4 is a flow chart showing the method 400 for a search engine to provide the open-type abstract information of webpage according to another embodiment of the invention;

FIG. 5 is a structure block diagram showing the device 500 for a search engine to crawl the open-type abstract information of webpage according to an embodiment of the invention;

FIG. 6 is a structure block diagram showing the device 600 for validating the open-type abstract information of webpage according to an embodiment of the invention;

FIG. 7 is a structure block diagram showing the device 700 for a search engine to provide the open-type abstract information of webpage according to an embodiment of the invention; and

FIG. 8 is a structure block diagram showing the device 800 for a search engine to provide the open-type abstract information of webpage according to another embodiment of the invention;

FIG. 9 schematically shows a block diagram of the server which is configured to execute the method according to the invention; and

FIG. 10 schematically shows the storage unit which is configured to hold or carry the program codes according to the method of the invention.

### DESCRIPTION OF THE EMBODIMENTS

Exemplary embodiments of the present disclosure will be described in detail with reference to the accompanying figures hereinafter. Although the exemplary embodiments of the disclosure are illustrated in the accompanying figures, it should be understood that the disclosure may be embodied in many different forms and should not be construed as being limited to the embodiments set forth herein. Rather, these embodiments are provided so that this disclosure will be understood thoroughly and completely and will fully convey the scope of the disclosure to those skilled in the art.

The following is further descriptions of the present invention, combining with the accompanying drawings and concrete embodiments.

Hereinafter, the exemplary embodiments of the disclosure will be described in more detail with reference to the accompanying drawings. Although the exemplary embodiments of the disclosure are shown in the accompanying drawings, it should be understood that the disclosure embodied in various forms should not be limited by the embodiments stated herein. In contrast, the embodiments are provided for a more thorough understanding of the disclosure and to be able to completely convey the scope of the disclosure to skilled personnel in the art.

In the embodiments of the invention, in order to enhance the display effects of the search results, the search engine may crawl the open-type abstract information of webpages, and then the search engine takes at least one open-type abstract information of webpages obtained by crawling as search result to display. Optionally, after crawling the open-type abstract information of the webpages, the open-type abstract information of the webpages is validated, and after the validation is passed, the search engine takes the open-type abstract information of the webpages as the search results to display.

Wherein, the above search engine refer to a system that provides search services for users, and displays the information relevant to users' searches to users' according to certain strategies, and collecting information from the internet using specific computer programs, and organizing and processing the information.

The above open-type abstract information may be provided together by the website combining with keywords of a webpage, and it may be displayed after it passes the validation system of the search engine. The open-type abstract information includes: the related information aiming at giving users general understandings of the webpage content, as well as the information of the relation between the webpage content and users' searches and queries. For example: besides ratings and comments, the information that helps users determine the correlation degree of the search, such as “pictures of the product”, “the price of the product”, “whether in stock”, etc., is also able to be added. Obviously, it should be understood that, in the embodiments of the invention, the expression form of the open-type abstract information is not limited.

### The First Embodiment

Firstly, the method for a search engine to crawl the open-type abstract information of webpage is illustrated hereinafter, concretely it includes: when the webpage information is crawled, detecting whether a preset identification of open-type abstract information is included in the webpage information; and if it is detected that the identification is included in the webpage information, crawling a protocol header which describes the structure of the open-type abstract information in the webpage information and webpage content that maps to the structure described in the webpage information.

As shown in FIG. 1, it is a flow chart of the method 100 for a search engine to crawl the open-type abstract information of webpage in the embodiment of the invention, and the method 100 begins in step S110. In step S110, when the webpage information is crawled, detecting whether a preset identification of open-type abstract information is included in the webpage information.

Wherein, whether the open-type abstract information is included in the crawled webpage information is determined through the preset identification of open-type abstract information. In the embodiment of the invention, the concrete form of the above preset identification of open-type abstract information is not limited.

Optionally, in the embodiment of the present invention, each webpage may include at least one piece of open-type abstract information, and each piece of open-type abstract information is related to a keyword of the corresponding webpage. When the search keyword input by a user matches the keyword of a webpage, the search engine is able to return and display the open-type abstract information related to the keyword of the webpage.

Wherein, the format of the open-type abstract information may be HTML (Hypertext Markup Language), HTML5, JavaScript, Flash, or CSS (Cascading Style Sheet). It is understandable that in the embodiment of the invention, the concrete format of the open-type abstract information is not limited.

If it is detected that the identification is included in the webpage information, step S130 is entered. In the step S130, the protocol header in the webpage information which describes the structure of the open-type abstract information and the webpage content mapped with the structure described in the webpage information are crawled.

Optionally, in the embodiment of the invention, the webpage content mapped with the structure described in the open-type abstract information includes at least one of the followings: text, picture, link, video and audio. It is understandable that in the embodiment of the invention, the concrete type of the webpage content is not limited.

Optionally, after step S130, step S150 may be entered. In step S150, the rendering result of the open-type abstract information is validated, and/or the format of the open-type abstract information is validated, and/or validate the webpage content of the open-type abstract information is validated.

Optionally, in the embodiment of the invention, in step S150, the step of validating the format of the open-type abstract information includes: validating whether the size of the webpage area occupied by the open-type abstract information exceeds a predefined threshold value.

For example: the predefined threshold value is 400 px×170 px, and if the size of the webpage area occupied in the open-type abstract information exceeds 400 px×170 px, then the validation is not passed. It is understandable that in the embodiment of the invention, the concrete scope of the threshold value is not limited.

Optionally, in the embodiment of the invention, in step S150, the step of validating the content of the open-type abstract information includes: validating whether a specific element is included in the content of the open-type abstract information. Optionally, the specific element includes at least one of a price and a discount rate.

For example: if the content of the open-type abstract information includes the concrete price and/or the discount rate of a product or service, then the validation is not passed. Therefore, by the embodiment of the invention, the open-type abstract information provided by the search engine is able to provide only abstract content, not provide other possible meanings or behaviors, such as price competition, etc. It is understandable that in the embodiment of the invention, the concrete content of the specific elements is not limited.

Optionally, in the embodiment of the invention, if the validation in step S150 is passed, step S170 may be entered.

In step S170, if the validation is passed, when a search request matching the keyword of a webpage is received, the rendering result of rendering the open-type abstract information is returned according to the protocol header and the webpage content and the render result is taken as the search result of the search request. For example: it is capable to adopt the existing rendering mode, and render the open-type abstract information according to the protocol header and the webpage content, which is not illustrated herein.

Optionally, in the embodiment of the invention, if the validation in step S150 is not passed, step S190 may be entered.

In step S190, when a search request matches the keyword of a webpage is received, default abstract information of the webpage is returned and taken as the search result of the search request.

Wherein, the above default abstract information may refer to the webpage abstract information crawled by adopting the Sitemap protocol, or the part which may be displayed after optimized in the webpage automatically recognized by the search engine. It is understandable that in the embodiment of the invention, the crawling mode of the default abstract information is not limited.

In the embodiment of the invention, when crawling the webpage information, when it is detected that the identification is included in the webpage information, it is capable to crawl the protocol header that describes the structure of the open-type abstract information in the webpage information and the webpage content that maps to the structure described in the open-type abstract information, thus facilitating to adjust the search engine to crawl the content of the open-type abstract information of webpage, greatly enriching the display forms of the abstract webpage information.

For example: assuming the webpage content that maps to the structure described in the open-type abstract information is text, the open-type abstract information includes: related information aiming at giving users general understandings of the webpage content, as well as the information of the relation between the webpage content and users' searches and queries. For example: besides “ratings” and “comments”, the information that helps users determine the correlation degree of the search, such as “pictures of the product”, “the price of the product”, “whether in stock”, etc., are also able to be added. If a search engine understands the content in the webpage, it is capable to display the above search result in the search results according to the content. This search result is able to help search users have intuitive understandings of whether the site and the user's original search intentions are related and matching, thereby obtaining a higher click rate.

It should be noted that the method shown in FIG. 1 is not limited to be carried out according to the shown order of the various steps, and the order of the various steps may be adjusted according to the need. In addition, the steps are not limited to the above step division, and the above steps may be further split into more steps or be combined into fewer steps.

### The Second Embodiment

After a search engine crawls the open-type abstract information of webpage, the open-type abstract information may be validated. In the following, the method for a search engine to validate the open-type abstract information of webpage is illustrated, concretely comprising: if it is detected that a preset identification of the open-type abstract information is included in the webpage information, validating whether the rendering result of rendering the open-type abstract information is successful; if the rendering result is successful, according to a predefined rule, validating the format of the open-type abstract information and/or validating the webpage content of the open-type abstract information.

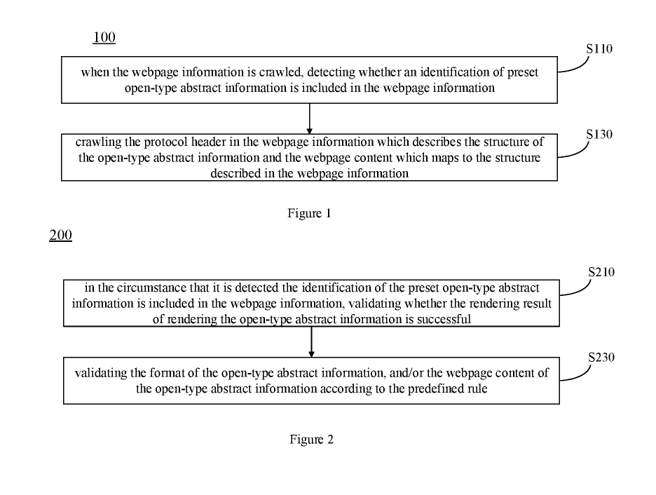

As shown in FIG. 2, it is a schematic diagram of the method 200 for validating the open-type abstract information of webpage in the embodiment of the invention, and the method 200 begins in step S210.

In step S210, if it is detected that the preset identification of the open-type abstract information is included in the webpage information, validating whether the rendering result of rendering the open-type abstract information is successful.

Wherein, whether the open-type abstract information is included in the crawled webpage information is determined through the preset identification of the open-type abstract information, and it is understandable that in the embodiment of the invention, the concrete form of the above preset identification of the open-type abstract information is not limited.

Optionally, in the embodiment of the invention, the open-type abstract information may adopt formats of HTML, HTML5, JavaScript, Flash, or CSS. It is understandable that in the embodiment of the invention, the concrete format of the open-type abstract information is not limited.

Optionally, in the embodiment of the invention, the JavaScript scripting language may be adopted to validate whether the rendering result of rendering the open-type abstract information is successful. It is understandable that in the embodiment of the invention, the concrete mode of validating whether the rendering result of rendering the open-type abstract information is successful.

Subsequently, if the rendering result is successful, in step S230, the format of the open-type abstract information is validated, and/or the webpage content of the open-type abstract information is validated according to the predefined rule.

Optionally, in the embodiment of the invention, the predefined rule may be: validating whether the size of the webpage area occupied in the open-type abstract information exceeds the predefined threshold value. For example: the predefined threshold value is 400 px×170 px, and if the size of the webpage area occupied in the open-type abstract information exceeds 400 px×170 px, then the validation is not passed. It is understandable that in the embodiment of the invention, the concrete scope of the threshold value is not limited.

Alternatively, in the embodiment of the invention, the predefined rule may also be: validating whether a specific element is included in the content of the open-type abstract information. For example: the specific element included at least one of the concrete price and the discount rate of a product or service. If the content of the open-type abstract information includes the price and/or the discount rate, then the validation is not passed. Therefore, by the embodiment of the invention, the open-type abstract information provided by the search engine is able to provide only the abstract content, not provide other possible meanings or behaviors, such as price competition, etc. It is understandable that in the embodiment of the invention, the concrete content of the specific elements is not limited.

Likewise, it is understandable that in the embodiment of the invention, the predefined rule is not limited.

Optionally, in the embodiment of the invention, the webpage content includes at least one of the followings: text, picture, link, video and audio. It is understandable that in the embodiment of the invention the concrete type of the webpage content is not limited.

Optionally, in the embodiment of the invention, after step S230, if the validation of the rendering result and the format of the open-type abstract information or the webpage content is passed, step S250 is entered.

In step S250, when receiving a search request that matches the keyword of the webpage, the rendering result of rendering the open-type abstract information of webpage is returned and taken as the search result of the search request.

Optionally, in the embodiment of the invention, the search result may adopt formats of HTML, SHTML, HTML5 or XML (Extensible Markup Language). It is understandable that in the embodiment of the invention, the concrete format of the search result is not limited.

Optionally, after step S230, if the validation of the rendering result and the format of the open-type abstract information or the webpage content are not passed, step S270 is entered.

In step S270, when receiving a search request that matches the keyword of the webpage, return the default abstract information of the webpage and take the default abstract information as the search result of the search request.

The above default abstract information may be crawled and obtained from at least one of webpages by adopting the existing sitemap protocol and other modes.

It should be noted that the method shown in FIG. 2 is not limited to be carried out according to the shown order of the various steps, and the order of the various steps may be adjusted according to the need. In addition, the steps are not limited to the above step division, and the above steps may be further split into more steps or be combined into fewer steps.

### The Third Embodiment

When a search engine crawls at least one piece of open-type abstract information of webpage, or after the validation of the open-type abstract information is passed, the search engine may take the open-type abstract information of webpage as the search result and display the open-type abstract information. In the following, the method for a search engine to provide the open-type abstract information of webpage is introduced.

In the embodiment of the invention, the method for a search engine to provide the open-type abstract information of webpage, concretely comprising: receiving a search request; searching webpages which match the search request in open-type abstract database; for the webpages which match the search request, returning the rendering results of rendering the open-type abstract information, so as to take the rendering results as the search results of the search request.

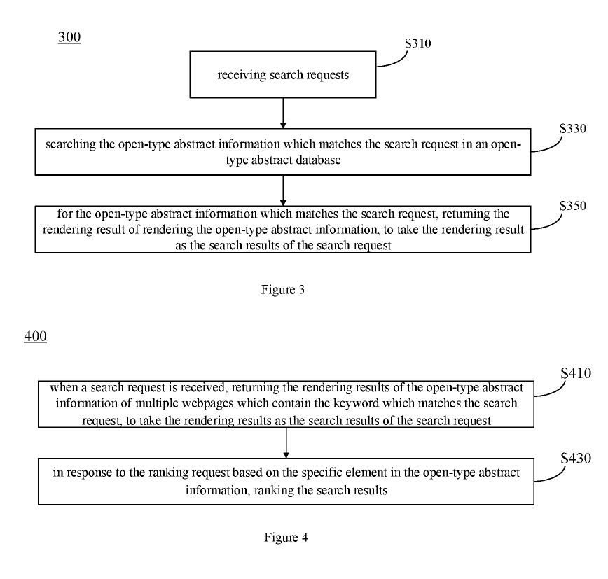

As shown in FIG. 3, it is a schematic diagram of the method 300 for a search engine to provide the open-type abstract information of webpage in the embodiment of the invention, and the method 300 begins in step S310. In step S310, search requests are received.

For example: a user inputs a search keyword in a search bar; then the client sends the URL (Uniform Resource Locator) constituted of the search keyword to a search engine on the network side.

Subsequently, in step S330, the open-type abstract information which matches the search request in an open-type abstract database is searched. Wherein, at least one piece of open-type abstract information is stored in the open-type abstract database beforehand.

Optionally, in the embodiment of the invention, the webpage content includes at least one of the followings: text, picture, link, video and audio. It is understandable that in the embodiment of the invention, the concrete type of the webpage content is not limited.

Subsequently, in step S350, for the open-type abstract information which matches the search request, the rendering result of rendering the open-type abstract information is returned, so as to take the rendering result as the search results of the search request. Optionally, in the search results, the open-type abstract information which is ranked at or near the top positions according to the search results is included.

Optionally, in the embodiment of the invention, in step S350, if multiple pieces of open-type abstract information is included in the webpage, the open-type abstract information that matches the search request most is determined, and the rendering result of rendering the open-type abstract information that matches most is returned, so as to be taken as the search result of the search request.

In the embodiment of the invention, the existing search engine algorithms may be adopted to calculate and obtain multiple pieces of matched open-type abstract information according a search request, then the open-type abstract information that matches most are determined from multiple open-type abstract information.

Optionally, in the embodiment of the invention, the search result adopts formats of HTML, SHTML, HTML5 or XML. It is understandable that in the embodiment of the invention, the concrete format of the search result is not limited.

Optionally, in the embodiment of the invention, in step S350, the open-type abstract information is rendered according to the protocol header that describes the structure of the open-type abstract information in the webpage information and the webpage content that maps to the structure described in it.

Optionally, in the embodiment of the invention, the webpage content includes at least one of the followings: text, picture, link, video and audio. It is understandable that in the embodiment of the invention, the concrete type of the webpage content is not limited.

Optionally, in the embodiment of the invention, formats of HTML, HTML5, JavaScript, Flash, or CSS are adopted, and the open-type abstract information is rendered according to the protocol header and the webpage content.

Optionally, in the embodiment of the invention, the search result adopts formats of HTML, SHTML, HTML5 or XML. It is understandable that in the embodiment of the invention, the format of the search result is not limited.

Optionally, in the embodiment of the invention, in step S310, in which search requests are received, a search request is received from the client, and if the open-type abstract information is included in the webpage, the rendering results of rendering the open-type abstract information are returned to be taken as the search results of the search request (step S330), the rendering results are returned to the client, so as to be displayed as the search results on the client.

It should be noted that the method shown in FIG. 3 is not limited to be carried out according to the shown order of the various steps, and the order of the various steps may be adjusted according to the need. In addition, the steps are not limited to the above step division, and the above steps may be further split into more steps or be combined into fewer steps.

### The Fourth Embodiment

In the following, another method for a search engine to provide the open-type abstract information of webpage is introduced, concretely comprising: when webpage information is crawled, detecting whether the protocol header that describes the structure of open-type abstract information is included in the webpage information; if it is detected the protocol header, crawling the protocol header and the webpage content that maps to the structure described in it, and rendering the open-type abstract information according to the protocol header and the webpage content; detecting whether specific element is included in the open-type abstract information, if the specific element is included in the open-type abstract information, crawling the specific element and the webpage information correspondingly; when a search request that matches the keyword of the webpage is received, returning the rendering results of the open-type abstract information of multiple webpages which contains the keyword which matches the search request, so as to take the rendering results as the search results of the search request; and in response to the ranking request based on the specific element in the open-type abstract information, ranking the search results.

As shown in FIG. 4, it is a schematic diagram of the method 400 for a search engine to display the open-type abstract information of webpage in the embodiment of the invention, and the method 400 begins in step S410.

In step S410, when a search request is received, returning the rendering results of the open-type abstract information of multiple webpages which contain the keyword which matches the search request, so as to take the rendering results as the search results of the search request.

Optionally, after a search server on the network side receives a search request sent from a terminal device, making matches according to the keyword in the search request, and obtain the rendering results of the open-type abstract information of multiple webpages which contain the keyword which matches the search request, and take the rendering results as the search results of the search request and return to the terminal device.

Subsequently, in step S430, in response to ranking request based on the specific element in the open-type abstract information, ranking the search results.

Optionally, the search server on the network side receives a ranking request based on the specific element in the open-type abstract information from a terminal device, rank the search results according to ways such as from high to low, or from low to high. It is understandable that in the embodiment of the invention, the concrete strategy of ranking is not limited.

Optionally, in the embodiment of the invention, before step S410, step S400 above-mentioned also includes: when the webpage content is crawled, detecting whether a preset identification of the open-type abstract information is included in it; then if it is detected that the identification is included in the webpage content, detecting whether the specific element is included in the open-type abstract information, and if the specific element is included in the open-type abstract information, storing the specific elements correspondingly with the keyword of the webpage and the open-type abstract information.

Optionally, in the embodiment of the invention, the webpage content includes at least one of the followings: text, picture, link, video and audio. It is understandable that in the embodiment of the invention, the concrete format of the webpage content is not limited.

Optionally, in the embodiment of the invention, in the step of storing the specific element correspondingly with the keyword of the webpage, the open-type abstract information, taking the specific element as the specific item and store it correspondingly with the keyword of the webpage and the open-type abstract information into the database of search engine.

Optionally, in the embodiment of the invention, in step S430, ranking the search results which contain the open-type abstract information at or near the top positions.

Optionally, in the embodiment of the invention, in step S430, according to the ascending or descending of the specific element, ranking the search results. Optionally, the specific element include at least one of the price, the discount rate, the favorable rate, the credit rating, and the sale.

Optionally, in the embodiment of the invention, the open-type abstract information adopts formats of HTML, HTML5, JavaScript, Flash, or CSS. It is understandable that in the embodiment of the invention, the concrete format of the open-type abstract information is not limited.

Optionally, in the embodiment of the invention, the search results adopts formats of HTML, SHTML, HTML5 or XML. It is understandable that in the embodiment of the invention, the concrete format of the search results is not limited.

It should be noted that the method shown in FIG. 4 is not limited to be carried out according to the shown order of the various steps, and the order of the various steps may be adjusted according to the need. In addition, the steps are not limited to the above step division, and the above steps may be further split into more steps or be combined into fewer steps.

### The Fifth Embodiment

As shown in FIG. 5, it is a schematic diagram showing the structure of the device 500 for a search engine to crawl open-type abstract information of webpage in the embodiment of the invention.

In the embodiment of the invention, the device 500 includes: a detection module 510 and a crawl module 530. Wherein, the detection module 510 is used to when crawling the webpage information, detect whether the preset identification of the open-type abstract information is included in it; the crawl module 530 is used to if it is detected that the identification is included in the webpage information, crawl the protocol header which describes the structure of the open-type abstract information in the webpage information and the webpage content mapped with the structure described in the open-type abstract information.

Optionally, in the embodiment of the invention, each webpage includes at least one of open-type abstract information, and each piece of open-type abstract information is related to a keyword of the corresponding webpage.

Optionally, in the embodiment of the invention, the webpage content, mapped with the structure described in the open-type abstract information, includes at least one of the followings: text, picture, link, video and audio.

Optionally, in the embodiment of the invention, the device 500 also includes: a validation module, used to validate the rendering result of the open-type abstract information, and/or validate the format of the open-type abstract information, and/or validate the webpage content of the open-type abstract information; if the validation is passed, when a search request matches the keyword of the webpage is received, return the rendering results of rendering the open-type abstract information according to the protocol header and the webpage content and take them as the search results of the search request.

Optionally, in the embodiment of the invention, the validation module is also used to if the validation is not passed, when receiving a search request that matches the keyword of the webpage, return the default abstract information of the webpage and take it as the search result of the search request.

Optionally, in the embodiment of the invention, the validation module is further used to validate whether the size of the webpage area occupied in the open-type abstract information exceeds the predefined threshold value; or the validation module is further used to validate whether the specific elements are included in the content of the open-type abstract information.

### The Sixth Embodiment

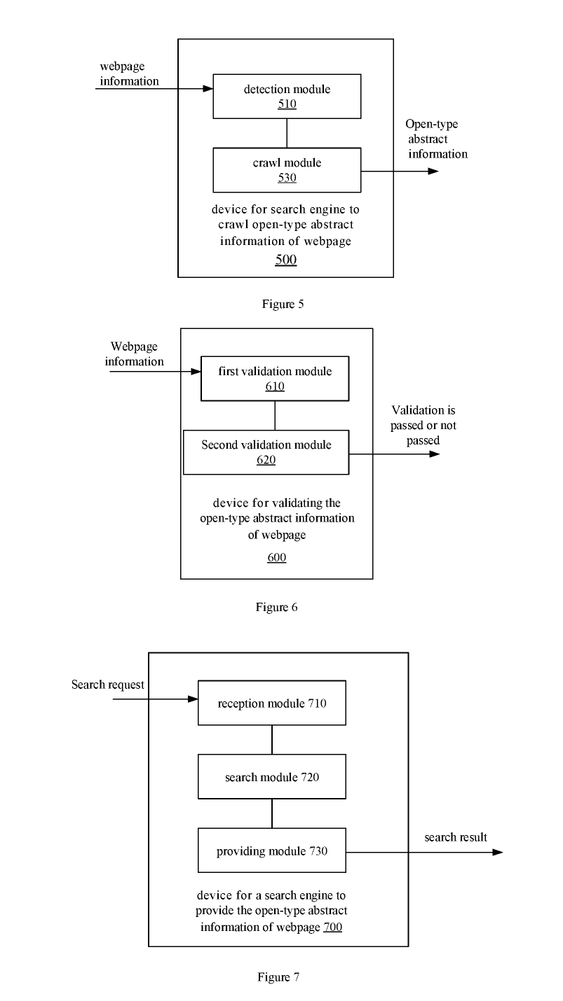

As shown in FIG. 6, it is a schematic diagram showing the structure of the device 600 for validating the open-type abstract information of webpage in the embodiment of the invention.

In the embodiment of the invention, the device 600 includes: a first validation module 610 and a second validation module 620. Wherein, the first validation module 610 is used to if it is detected that the preset identification of the open-type abstract information is included in the webpage information, validate whether the rendering result of rendering the open-type abstract information is successful; and the second validation module 620 is used to according to the predefined rule, validate the format of the open-type abstract information and/or the webpage content.

Optionally, in the embodiment of the invention, the device 600 also includes: a result return module 630, used to if the validation of the rendering result, and the format, and/or the webpage content are passed, when a search request that matches the keyword of the webpage is received, return the rendering results of the open-type abstract information of webpage, so as to take the rendering results as the search results of the search request.

Optionally, in the embodiment of the invention, the result return module 630 is also used to if the validation of the rendering result, or the format, or the webpage content are not passed, when receiving a search request that matches the keyword of the webpage, return the default abstract information of the webpage, so as to take it as the search result of the search request.

Optionally, in the embodiment of the invention, the second validation module 620 is further used to validate whether the size of the webpage area occupied in the open-type abstract information exceeds a predefined threshold value.

Optionally, in the embodiment of the invention, the second validation module 620 is further used to validate whether the specific element is included in the content of the open-type abstract information.

### The Seventh Embodiment

As shown in FIG. 7, it is a schematic diagram showing the structure of the device 700 for a search engine to provide the open-type abstract information of webpage in the embodiment of the invention.

In the embodiment of the invention, the device 700 includes: a receiving module 710, a search module 720, and a providing module 730. Wherein, the receiving module 710 is used to receive search requests; the search module 720 is used to search the webpage content which matches the search request in open-type abstract database; and the providing module 730 is used to for the webpages which match the search request, return the rendering results of rendering the open-type abstract information so as to take them as the search results of the search request.

Optionally, in the embodiment of the invention, the providing module 730 is further used to if multiple open-type abstract information is included in a webpage, determine the open-type abstract information that matches the search request most, and return the rendering result of rendering the open-type abstract information that matches most so as to take it as the search result of the search request.

Optionally, in the embodiment of the invention, the providing module 730 is also used to according to the protocol header that describes the structure of the open-type abstract information in the webpage information and the webpage content that maps to the structure described in it, render the open-type abstract information.

Optionally, in the embodiment of the invention, the receiving module 710 is used to receive a search request from client, and the providing module return the rendering results to the client, so as to display them as the search results on the client.

### The Eighth Embodiment

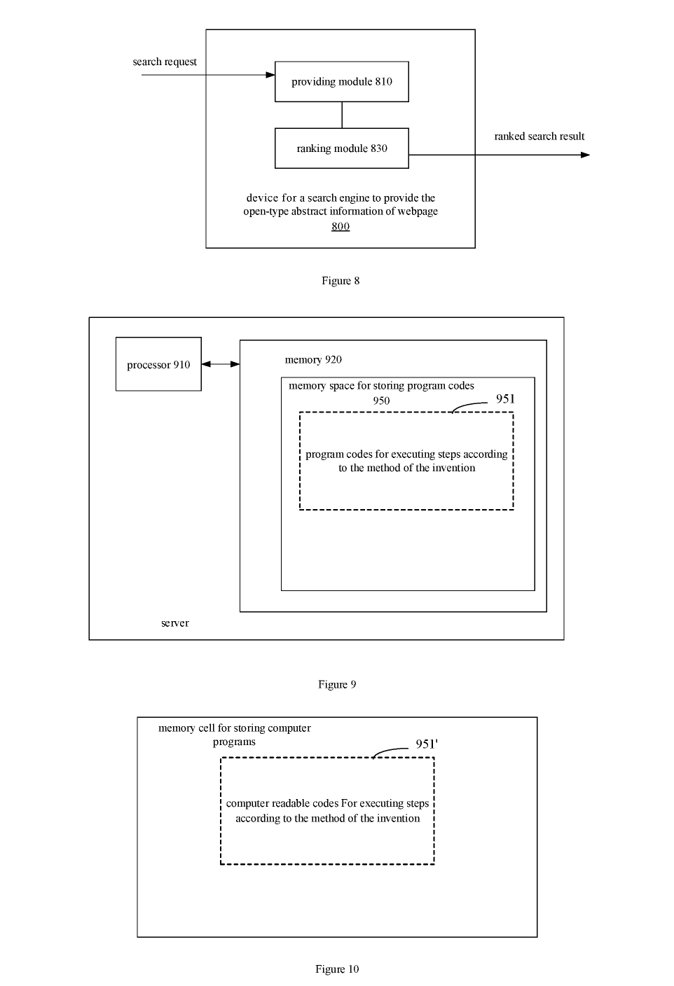

As shown in FIG. 8, it is a schematic diagram showing the structure of the device 800 for a search engine to provide the open-type abstract information of webpage in the embodiment of the invention.

The device 800 includes a providing module 810 and a ranking module 830. Wherein, the providing module 810 is used to when a search request is received, return the rendering results of the open-type abstract information of multiple webpages which contain the keyword which match the search request, so as to take them as the search results of the search request; and the ranking module 830 is used to in response to the ranking request based on the specific elements in the open-type abstract information, rank the search results.

Optionally, in the embodiment of the invention, the device 800 also includes: the first detection module 850, used to when the webpage information is crawled, detect whether the preset identification of the open-type abstract information is included in it; the second detection module 870, used to if it is detected that the identification is included in the webpage content, detect whether a specific element is included in the open-type abstract information, and if the specific element is included in the open-type abstract information, store the specific element correspondingly with the keyword of the webpage and the open-type abstract information.

Optionally, in the embodiment of the invention, the second detection module 870 is further used to take the specific element as the specific item and store it correspondingly with the keyword of the webpage and the open-type abstract information into the database of search engine.

Optionally, in the embodiment of the invention, the ranking module 830 is further used to rank the search results which contain the open-type abstract information at or near the top positions.

Optionally, in the embodiment of the invention, the ranking module 830 is further used to according to the ascending or descending of the specific element, rank the search results.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the interne websites, or be provided in carrier, or be provided in other manners.

For example, FIG. 9 illustrates a block diagram of a server for executing the method according the disclosure, such as a search engine server. Traditionally, the search engine server includes a processor 910 and a computer program product or a computer readable medium in form of a memory 930. The memory 930 could be electronic memories such as flash memory, EEPROM (Electrically Erasable Programmable Read-Only Memory), EPROM, hard disk or ROM. The memory 930 has a memory space 950 for executing program codes 951 of any steps in the above methods. For example, the memory space 950 for program codes may include respective program codes 951 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 10. The memory cells may be provided with memory sections, memory spaces, etc., similar to the memory 930 of the server as shown in FIG. 9. The program codes may be compressed for example in an appropriate form. Usually, the memory cell includes computer readable codes 951′ which can be read for example by processors 910. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

1. A method for a search engine to crawl open-type abstract information of a webpage, comprises:
detecting whether a preset identification of open-type abstract information is included in the webpage information when the webpage information is crawled; and
if it is detected that the identification is included in the webpage information, crawling a protocol header in the webpage information which describes structure of the open-type abstract information and webpage content mapped with the structure described in the open-type abstract information.

2. The method according to claim 1, wherein, each webpage comprises at least one piece of open-type abstract information, and each piece of open-type abstract information is related to a keyword of the corresponding webpage.

3. The method according to claim 1, wherein, the webpage content mapped with the structure described in the open-type abstract information includes at least one of the types of: text, picture, link, video and audio.

4. The method according to claim 1, wherein the method further comprises:
validating a rendering result of the open-type abstract information, or validating a format of the open-type abstract information, or validating webpage content of the open-type abstract information;
if the validation is passed, when a search request matching a keyword of the webpage is received, returning the rendering result of rendering the open-type abstract information according to the protocol header and the webpage content and taking the rendering result as a search result of the search request if the validation is not passed, when the search request matching the keyword of the webpage is received, returning default abstract information of the webpage and taking the default abstract information as the search result of the search request.

5. (canceled)

6. The method according to claim 4, wherein, the steps of
validating the format of the open-type abstract information comprises:
validating whether the size of a webpage area occupied by the open-type abstract information exceeds a predefined threshold value;
the steps of validating the webpage content of the open-type abstract information comprises:
validating whether a specific element is included in the webpage content of the open-type abstract information.

7.-8. (canceled)

9. A server for a search engine to crawl open-type abstract information of a webpage, comprising:
a memory having instructions stored thereon;
a processor configured to execute the instructions to perform operations for the search engine to crawl the open-type abstract information of the webpage, comprising:
detecting whether a preset identification of open-type abstract information is included in webpage information when the webpage information is crawled;
crawling a protocol header in the webpage information which describes structure of the open-type abstract information and webpage content mapped with the structure described in the open-type abstract information if it is detected the identification is included in the webpage information.

10.-23. (canceled)

24. A server for a search engine to provide open-type abstract information of a webpage, comprising:
a memory having instructions stored thereon;
a processor configured to execute the instructions to perform operations for the search engine to provide the open-type abstract information of the webpage, comprising:
receiving a search request;
searching webpage content which matches the search request in an open-type abstract database; and
returning rendering result of rendering the open-type abstract information to the webpage matching the search request, to take the rendering result as a search result of the search request.

25. (canceled)

26. The server according to claim 24, wherein, the open-type abstract information is rendered according to a protocol header in the webpage information which describes the structure of the open-type abstract information and the webpage content mapped with the structure described in the protocol header.

27. The server according to claim 26, wherein, format of HTML, HTML5, JavaScript, Flash, or CSS is adopted to render the open-type abstract information according to the protocol header and the webpage content.

28. The server according to claim 24, wherein, the webpage content comprises at least one of the types of: text, picture, link, video and audio.

29. The server according to claim 24, wherein, the format of search result is HTML, SHTML, HTML5 or XML.

30. The server according to claim 24, wherein, in receiving the search request, the search request is received from a client, and
in returning the rendering result of rendering the open-type abstract information to take the rendering result as the search result of the search request if the open-type abstract information is included in the webpage, the rendering result is returned to the client to be displayed on the client as the search result.

31. The server according to claim 24, wherein, in the search results, the search result which includes the open-type abstract information is ranked at or near the top positions.

32.-46. (canceled)

47. The server according to claim 9, wherein, each webpage comprises at least one piece of open-type abstract information, and each piece of open-type abstract information is related to a keyword of the corresponding webpage.

48. The server according to claim 9, wherein, the webpage content mapped with the structure described in the open-type abstract information includes at least one of the types of: text, picture, link, video and audio.

49. The server according to claim 9, wherein the processor is further configured to:
validating a rendering result of the open-type abstract information, or validating a format of the open-type abstract information, or validating webpage content of the open-type abstract information;
if the validation is passed, when a search request matching a keyword of the webpage is received, returning the rendering result of rendering the open-type abstract information according to the protocol header and the webpage content and taking the rendering result as a search result of the search request;
if the validation is not passed, when the search request matching the keyword of the webpage is received, returning default abstract information of the webpage and taking the default abstract information as the search result of the search request.

50. The server according to claim 49, wherein, validating the format of the open-type abstract information comprises:
validating whether the size of a webpage area occupied by the open-type abstract information exceeds a predefined threshold value;
validating the webpage content of the open-type abstract information comprises:
validating whether a specific element is included in the webpage content of the open-type abstract information.

51. The server according to claim 24, wherein the processor is further configured to perform:
ranking the search results in response to a ranking request based on a specific element in the open-type abstract information.

52. The server according to claim 51, wherein, in ranking the search results in response to the ranking request based on the specific element in the open-type abstract information, the search results which include the open-type abstract information are ranked at or near the top positions.

53. The server according to claim 51, wherein, in ranking the search results in response to the ranking request based on the specific element in the open-type abstract information, the search result is ranked according to ascending or descending of the specific element.
